(19) United States
(12) Patent Application Publication
(10) Pub. No.: US 2004/0068840 A1
(43) Pub. Date: Apr. 15, 2004

(54) Method and device for aligning an adjustable hinge

(76) Inventors: Kurt R. Thomas, Durand, IL (US); David R. Cress, Janesville, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/270,920

(22) Filed: Oct. 15, 2002

(51) Int. Cl. E05D 7/04

(52) U.S. Cl. 16/245

(57) ABSTRACT

An adjustable hinge may include a mounting plate, a door wing and a hinge arm. The hinge arm, which connects the door wing to the mounting plate, may include a slider portion and an alignment portion and a cam. The slider portion and the alignment portion, may be adapted to traverse relative to each other by the rotational movement of the cam. The alignment portion may include a one-piece alignment mechanism, having a base and a pair of walls, and may be adapted to align the slider portion to the alignment portion. The pair of walls may have upper portions, wherein the upper portions of the walls are angled toward each other.

### FIELD OF THE DISCLOSURE

The present disclosure generally relates to an alignment mechanism and, more particularly, to an alignment mechanism for an adjustable hinge having an adjustment member.

### BACKGROUND OF THE DISCLOSURE

Adjustable hinges, and particularly adjustable hinges having a cam system are often used to pivot a door, or the like, on a frame, such as a cabinet, chest, armoire, etc. The adjustable feature of the hinge, allows the user to make adjustments to the position of the door relative to the frame during and/or after the installation of the door to the frame via the hinge.

In the past, adjustable hinges having two piece hinge arms, have been produced to allow for the adjustment between the frame and door. More specifically, the hinge arm had two pieces that were able to slide relative to each other and would then be fastened together using a screw, or the like. In more advanced versions of adjustable hinges, the screw has been replaced with a cam, thereby allowing the user to make dynamic adjustments to the hinge, without having to loosen or take apart the hinge.

In both of the above adjustable hinges, it is necessary to align and secure the two sections of the hinge arm to each other to prevent the twisting or buckling of the hinge arm. More specifically, because the two pieces of the hinge arm are connected by a cam, screw, or other fastener, the weight of the door may create enough force to loosen the fastener and eventually move the two pieces relative to each other. Similarly, it is desired to have an alignment mechanism between the two pieces during adjustment of the hinge to allow for easier and more consistent adjustment.

Past hinges have used several variations of alignment mechanisms to align the two pieces of the hinge arm relative to each other. Such variations include milling one of the two pieces of the hinge arm to create a groove or track thereby allowing the second piece to traverse within the groove or track. Other variations have utilized tracks that are constructed from several pieces, to encapsulate or otherwise trap the second piece.

### SUMMARY OF THE DISCLOSURE

In accordance with one aspect of the disclosure among others, an adjustable hinge is disclosed. In one exemplary embodiment, the adjustable hinge includes a mounting plate, a door wing and a hinge arm. The hinge arm may connect the door wing to the mounting plate, and may include a first portion and a second portion which may be adapted to traverse relative to each other by the rotational movement of an adjustment member. The first portion includes a one-piece alignment mechanism having a base and a pair of walls adapted to align the second portion to the first portion. The pair of walls further include upper portions, wherein the upper portions of the walls are angled toward each other.

In accordance with another aspect of the disclosure among others, a method of aligning an adjustable hinge is disclosed. In one exemplary embodiment, the method includes providing a slider portion adapted to traverse within a one-piece alignment mechanism, wherein the one-piece alignment mechanism includes a base and a pair of walls having upper portions. The method further includes locating the slider portion within the one-piece alignment mechanism, and bending the upper portions of the pair of walls toward each other, thereby creating a track for the slider portion to traverse within.

### BRIEF DESCRIPTION OF THE DRAWINGS

FIG. 1 is a perspective view of one embodiment of an adjustable hinge;

FIG. 2 is an exploded view of one embodiment of a hinge arm;

FIG. 3 is a front view of the hinge arm of FIG. 2; and

FIG. 4 is a front view of an adjustment mechanism of the hinge arm of FIG. 2.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention as defined by the appended claims.

### DETAILED DESCRIPTION

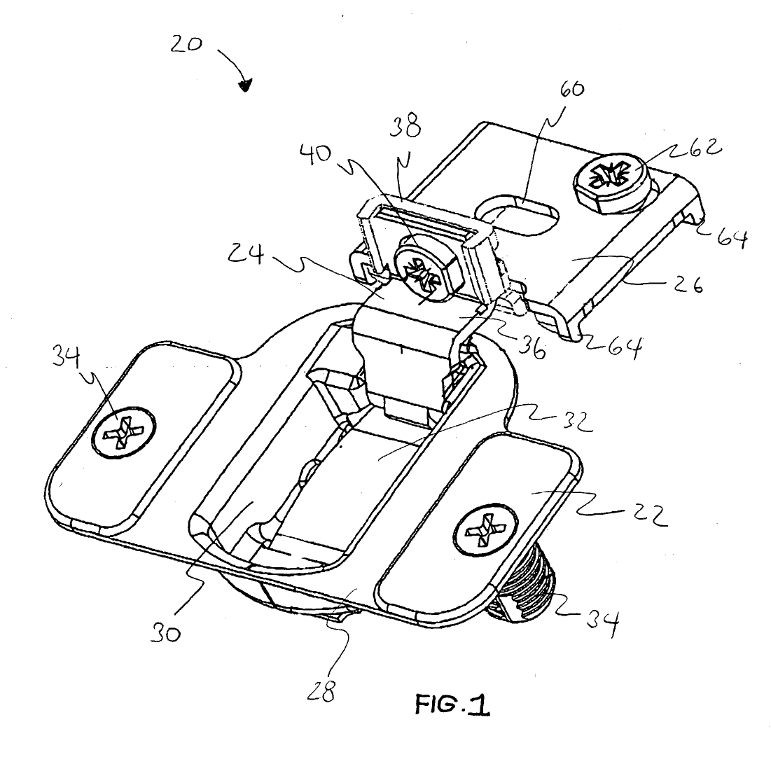

Referring now to the drawings, and with specific reference to FIG. 1, an adjustable hinge as constructed in accordance with the teachings of the disclosure is generally depicted by reference numeral 20. As shown therein, the hinge 20, includes, a mounting plate 22, a hinge arm 24, and a door wing 26.

The hinge 20 may be one of several types of hinges, including but limited to, visible hinges, invisible hinges, cup-type hinges, etc., but will herein be described for illustrative purposes only, as an invisible cup-type hinge.

In one exemplary embodiment, the mounting plate 22 may include a body 28, a cup 30, a spring 32 and/or dowels 34. The mounting plate 22 may, however, include additional, other and/or lesser elements. The mounting plate 22 may be adapted to mount to a frame or the like, and be adapted to pivotally attach to the hinge arm 24.

In one exemplary embodiment, the hinge arm 24 may include a slider portion 36, an alignment portion 38 and an adjustment member 40. The slider portion 36 may include a body 42 and an aperture 44. The aperture 44 may be of any shape adaptable to the adjustment mechanism used, including, but not limited to, round oval, square, slot shaped, or the like. The alignment portion 38, may include an aperture 54, and an alignment mechanism having a body 46, a base 48, a pair of walls 50, 52. The adjustment member 40, may be any type of fastener or connector adaptable to engage the slider portion 36 and the alignment portion, including, but not limited to, a screw, bolt, pin, cam, etc.

In one exemplary embodiment, the door wing 26 may include a fastener aperture 60, a cam 62 and/or guides 64. The door wing 26 may, however, include additional, other and/or lesser elements. The door wing 26 may be adapted to mount to a door or the like, and be adapted to attach to the hinge arm 24.

In operation, the hinge 20 may be used to pivot a door relative to a frame, such as a cabinet, chest, armoire, etc., but may also be used to pivot many other members relative to each other.

In one exemplary embodiment, the hinge 20 may be fastened to the frame at the mounting plate 22, and may be fastened to the door at the door wing 26. The mounting plate 22 may be connected to the door wing 26 by the adjustable hinge arm 24. The adjustable hinge arm 24, may include the slider portion 36 and the alignment portion 38, wherein the slider portion 36 may be adapted to traverse relative to the alignment portion 38, thereby adjusting the hinge 20.

In one exemplary embodiment, the adjusting of the hinge 20 may be accomplished with the adjustment member 40, such as a cam. To adjust the hinge 20, the user may rotate the cam 40 thereby traversing the alignment portion 38 and the slider portion 36 relative to each other. More specifically, the alignment portion 38 and the slider portion 36 may be located relative to each other to allow the apertures 44 and 54 to be aligned. With the apertures 44, 54 aligned, the lower portion 66 of the cam 40, which may be concentric to the aperture 54, may be located within the aperture 54, and the middle portion 68 of the cam 40, which may be non-concentric to the aperture 54 and may be smaller in diameter than the aperture 44, may be located in the apertures 44. As the cam 40 is rotated, the cam 40 may rotate about the lower portion 66 of the cam 40, and the middle portion 68 of the cam 40 may force the slider portion 36 toward or away from the alignment portion 38, depending on the rotational direction of the cam 40.

To enhance functionality of the slider portion 36 and the alignment portion 38, the pair of walls 50, 52 of the alignment mechanism may be adapted to align the slider portion 36 and the alignment portion 38 relative to each other. The pair of walls 50, 52, aside from aligning the slider portion 36 and the alignment portion 38, may also serve other benefits, including, but not limited to, providing stability to the hinge arm 24, providing a track in the alignment portion 38 for the sliding portion 36 to traverse within, and/or to prevent the separation of the slider portion 36 from the alignment portion 38.

In one exemplary embodiment, the slider portion 36 may be placed adjacent to the alignment portion 38, such that the underside of the slider portion 38 is in contact with the base 48 of the alignment portion 38, and such that the pair of walls 50, 52, protruding in a substantially perpendicular manner from the base 48, are located on either side of the slider portion 36. To complete the track within which the slider portion 36 may traverse, upper portions 70, 72 of the pair of walls 50, 52 may be bent, and therefore angled toward each other. The walls 50, 52 may be bent before during or after the slider portion is in contact with the base, and the walls 50, 52 may be bent in varying degrees. For example, the walls 50, 52 may be bent according to the thickness of the slider portion 36, or may be bent depending on the amount of force or friction is desired between the walls 50, 52, the slider portion 36 and/or the base 48. More particularly, the walls 50, 52 may be bent enough to allow movement between the slider potion 36 and the alignment portion 38, to ensure a sturdy connection between the slider portion 36 and the alignment portion 38, and/or to allow for only unidirectional movement of the alignment portion 38 relative to the slider portion 36.

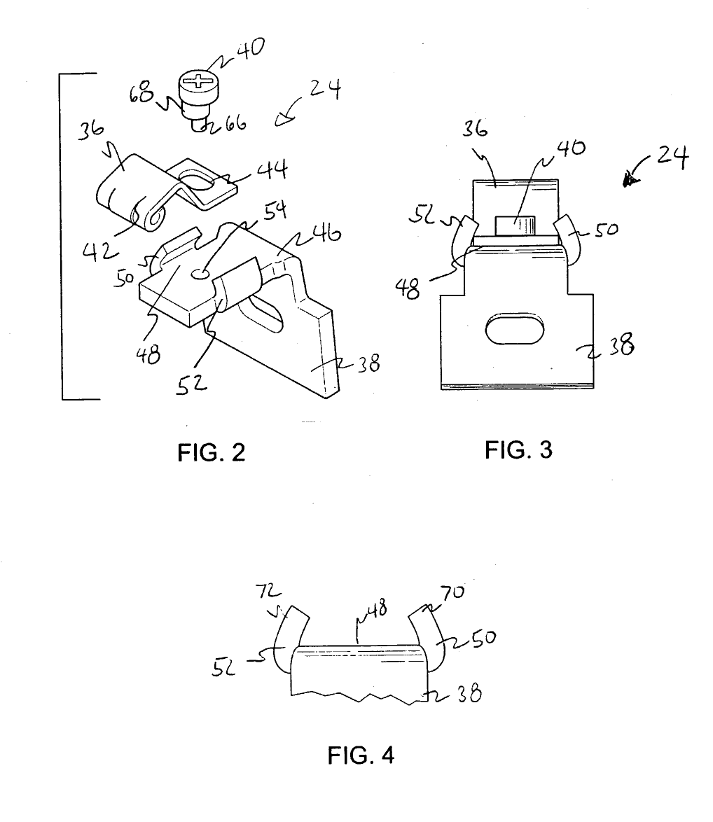

In one exemplary embodiment, when the hinge 20, or at least the slider portion 36, the alignment portion 38 and the cam 40 are connected, the user may rotate the cam 40 in either a clockwise or counterclockwise direction, thereby causing the relative movement of the slider portion 36 and the alignment portion 38. More specifically, as the cam 40 is rotated in the clockwise direction, as positioned in FIG. 2, the lower portion 66 of the cam 40 will be located in, and will rotate about, aperture 54 located in the alignment portion 38. The non-concentric middle portion 68 of the cam 40 will push on one of the sides of the aperture 44, and cause the sliding portion 36 to traverse either closer to or away from the alignment portion 38.

The foregoing detailed description has been given for clearness of understanding only and no unnecessary limitations should be understood therefrom, as modifications will be apparent to those skilled in the art.

What is claimed is:

1. An adjustable hinge comprising:
a mounting plate;
a door wing;
a hinge arm including a first portion and a second portion, wherein the hinge arm connects the door wing to the mounting plate;
the first portion including a one-piece alignment mechanism adapted to align the second portion to the first portion;
the one-piece alignment mechanism including a base and a pair of walls; and
the pair of walls having upper portions, wherein the upper portions of the walls are angled toward each other.

2. The adjustable hinge of claim 1 further comprising an alignment member.

3. The adjustable hinge of claim 2 wherein the rotational movement of the alignment member traverses the first and second portions relative to each other.

4. The adjustable hinge of claim 1 wherein the door wing and the hinge arm are the same component.

5. The adjustable hinge of claim 2 wherein the adjustment member is a cam.

6. A alignment system for an adjustable hinge comprising:
an alignment portion having a one-piece alignment mechanism;
the one-piece alignment mechanism having a base, a first wall and a second wall;
a slider portion adapted to traverse within the alignment mechanism; and
the first and second wall including upper portions, wherein the upper portions of the walls are angled toward each other.

7. The alignment system of claim 6 further including an alignment member adapted to engage with an aperture in the slider portion and with an apertures in the alignment portion.

8. A method of aligning an adjustable hinge comprising:
providing a slider portion adapted to traverse within a one-piece alignment portion, wherein the one-piece alignment portion includes an alignment mechanism having a base and a pair of walls, the pair of walls having upper portions;
locating the slider portion within the one-piece alignment portion; and
bending the upper portions toward each other, thereby creating a track for the slider portion to traverse within.

9. The method of claim 8 further providing a cam adapted to rotate within the alignment portion and the slider portion.

10. The method of claim 9 including rotating the cam thereby traversing the alignment portion and the slider portion relative to each other.

11. An adjustable hinge comprising:
a mounting plate;
a door wing;
a hinge arm including a first portion, a second portion and an alignment member, wherein the hinge arm connects the door wing to the mounting plate;
the first and second portion being adapted to traverse relative to each other by rotational movement of the alignment member;
the first portion including a one-piece alignment mechanism adapted to align the second portion to the first portion; and
the one-piece alignment mechanism including a base and a pair of walls;
the pair of walls having an upper portions and a lower portions, wherein the upper portions of the walls are angled toward each other.
